(19) United States
(12) Patent Application Publication
(10) Pub. No.: US 2024/0224881 A1
(43) Pub. Date: Jul. 11, 2024

(54) USE OF A MOBILE DEVICE THAT DELIVERS LIGHT PULSES TO A PLANT MATERIAL FOR CONFERRING PROTECTION AGAINST THE EFFECTS ASSOCIATED WITH ABIOTIC STRESSES

(71) Applicants: UV BOOSTING, Boulogne Billancourt (FR); Avignon Université, Avignon cedex 01 (FR)

(72) Inventors: Yves MATTON, Fontenay aux Roses (FR); François SEMENT, Morières lès Avignon (FR); Baptiste ROUESNE, Paris (FR); Loïc LEDERMANN, Wuenheim (FR); Nicolas PASCOUAU, Leognan (FR); Julien CHAREL, Neuville sur Seine (FR); Hugo GONCALVES, Leognan (FR); Jawad AARROUF, Le Pontet (FR); Laurent URBAN, Mollégès (FR); Michel JACOB, Avirey-Lingey (FR)

(73) Assignees: UV BOOSTING, Boulogne Billancourt (FR); Avignon Université, Avignon cedex 01 (FR)

(21) Appl. No.: 18/572,282

(22) PCT Filed: Jun. 20, 2022
(86) PCT No.: PCT/EP2022/066721

§ 371 Date: Dec. 20, 2023

(30) Foreign Application Priority Data
Jun. 21, 2021 (FR) FR2106583

(51) Int. Cl. A01G 7/04

(52) U.S. Cl. CPC A01G 7/045

(57) ABSTRACT

A mobile light exposure device that delivers light pulses to a plant material has a first emission module that has at least one light treatment panel configured to emit one or more light pulses; has a second module configured for adjusting and/or switching on an optical power density of the light treatment panel and optionally a temperature of the light treatment panel; and has a locomotive means for moving the mobile light exposure device. In operation, the mobile light exposure device attenuates impacts on plant material associated with abiotic stresses, such as stresses associated with edaphic, climatic and/or chemical factors.

### TECHNICAL FIELD

The present invention relates to the field of agronomy. It relates more particularly to the use of a mobile light exposure device that delivers light pulses to a plant material to prevent against impacts and minimize harmful consequences on said plant material, associated with abiotic stresses, preferentially stresses related to edaphic, climatic and/or chemical factors, as well as an associated method for preventing against said impacts.

### PRIOR ART

Because of their immobile nature, plants are exposed to different factors, sometimes hostile, such as abiotic stresses.

Abiotic stresses refers to environmental factors that disturb the functioning of a plant. Among these factors, there are various environmental factors such as, for example, polluted or salt-rich soil, a lack of water, large variations in temperature, freezing, wind or hail.

Faced with these abiotic stresses, plants have adaptation mechanisms that allow them to combat said stresses for a limited period of time. However, in the event of prolonged stress, the quality and yield of the plants can be impacted.

These mechanisms are reflected in particular by the activation of certain genes which make it possible to synthesize response proteins to specific or non-specific stress.

In order to avoid partial or total destruction of the plants, there already exist certain solutions for combating abiotic stresses, in particular during stresses linked to climatic factors.

In the case of freezing for example, it is conventionally recommended to implement techniques to avoid the formation of ice on the plants.

The main direct control means known against freezing are the following:
covering the soil;
forming smoke or fog,
spraying water at a low flow rate;
mixing the air using anti-freeze towers; or
heating through the use of heaters with fuel or paraffin candles to heat the air.

More spectacularly, helicopters have also been mobilized in order to combat freezing. Their air scavenging action may sometimes be sufficient to increase the temperature by a few degrees and thus prevent the partial or total annihilation of the crops. Although on a technical level the results appear to be convincing, on an ecological and financial level this solution does not appear to be viable. Moreover, implementation requires a great deal of preparation.

The use of some of these techniques may on the one hand be expensive and/or polluting and, on the other hand, constraining because these control means must be set up at a time when they can prevent the episode of freezing.

For example, the company WEENAT™ has developed a connected gel sensor making it possible to monitor the risk of crop freezing in real time in order to provide for the implementation of the means for combating freezing.

However, this device does not propose an alternative to conventional means for combating freezing, which mostly remain restrictive to implement.

Document CN210782298 discloses an effective thermal protection coating cloth resistant to low temperatures and anti-aging for winter protection of grapevines. According to this document, the superposition of a polyethylene contact layer, a lower tie layer, a polyethylene braid layer, an upper tie layer and an outer polyethylene layer allows for good heat preservation, great structural strength, resistance to low temperatures. However, the use of such a cloth is particularly tedious, time-consuming, expensive, and requires a large amount of materials that are not necessarily recyclable.

In the context of the development of environmentally respectful and non-polluting agriculture, it is necessary to find alternative solutions that are simpler to implement and, if possible, less expensive.

### Technical Problem

Considering the foregoing, a problem that the present invention proposes to solve consists of proposing a novel method for preventing or combating impacts linked to abiotic stresses on a plant material, thus minimizing the harmful consequences on said plant material.

This alternative must make it possible to obtain a plant material that is more resistant to abiotic stresses such as stresses related to edaphic, climatic and/or chemical factors, without deterioration, and whose growth and development is not quantitatively or qualitatively affected, or is to a lesser degree.

Furthermore, the use of the device must not be polluting or pollutes less, in order to preserve the environment, while also being simple to put in place.

Its applications must be easily achievable at different scales, whether in a greenhouse or in a field.

### Technical Solution

The first subject matter of this problem posed is the use of a mobile light exposure device that delivers light pulses to a plant material comprising:
a first module for emitting one or more light pulses, comprising at least one light treatment panel;
a second module for adjusting and/or switching on, remote from or on the device, for adjusting and/or switching on the optical power density of the treatment panel and optionally the temperature of said panel; and
a locomotive means allowing for moving said device;
   for preventing and/or attenuating the impacts on the plant material which are associated with abiotic stresses, preferably stresses associated with edaphic, climatic and/or chemical factors.

The Applicant was able to demonstrate that the treatment of the cultures by light is an interesting approach that can be placed in order to prevent impacts linked to abiotic stresses.

Indeed, light is an important environmental factor which regulates the growth and development of plants. The plants need light not only for photosynthesis, vegetative growth, but also for regulating the development processes of reproductive organs.

Sunlight is particularly composed of ultraviolet radiations. Among these forms of radiations, only UV-A (320-400 nm) and UV-B (280-320 nm) reach the Earth's surface because UV-C radiations (200-280 nm) are absorbed by the ozone layer.

UV-C light can be artificially created by different physical processes. There are different types of lamps, in particular light-emitting diodes (LEDs), low-pressure mercury vapor lamps or xenon lamps which allow UV-C radiation emission.

Currently, UV-C radiations are known to be used for the purposes of disinfection and removal but their use to prevent and minimize the harmful consequences of abiotic stress is not being considered.

More particularly, the Applicant has demonstrated that radiations, in particular UV-C, delivered to a plant in the form of light pulses has a preventive effect on plants which makes it possible to reduce the impacts of abiotic stresses.

Another subject matter of the invention is a method for preventing and/or attenuating impacts of abiotic stresses on a plant material, by delivery of light pulses on said plant material, comprising the following steps of:
placing a mobile light exposure device comprising a first module for emitting one or more light pulses, comprising at least one light-treatment panel; a second module for adjusting and/or switching on, remote from or on the device, for adjusting and/or switching on the optical power density of the treatment panel and optionally the temperature of said panel; and a locomotive means allowing the movement of said device, on a farm comprising plantings to be treated;
passing said device delivering light pulses (UV-C, UV-B, UV-A, visible light) through the plantings, combined with direct exposure of said plant material from plantings to light pulses of identical or different wavelengths and/or durations,
   wherein the wavelengths are identical or different and are between 200 nm and 780 nm (UV-C, UV-B, UV-A, visible light), preferentially between 200 nm and 280 nm (UV-C) and in that the exposure times are identical or different but of a duration less than or equal to four seconds, preferentially less than or equal to two seconds.

### Benefits Provided

The developed invention consists in the use of a mobile device emitting light pulses on a plant material, having qualities of adaptability and of regular ease of use for the treatment of crops of variable sizes.

Fighting global warming is a significant current issue, promoting the use of solutions that emit less greenhouse gases is preferred.

The use of a device according to the invention produces little gray energy and is therefore more environmentally friendly than the solutions currently existing.

Using UV radiations preferentially UV-C in the form of light pulses allowing shorter exposures times is more advantageous for prevention against impacts related to abiotic stresses.

The Applicant could also demonstrate that the application of light pulses to a plant material in particular:
a reduced duration of applying the UV-C rays;
a stimulation of the production of defense proteins against abiotic stresses;
a better yield of plants having been exposed to abiotic stresses;
a better resistance of the plants exposed to a low temperature as in the event of a freeze, and
a better resistance of the plants exposed to a high temperature as in the event of a heat wave.

### BRIEF DESCRIPTION OF THE DRAWINGS

The invention and its advantages will be better understood on reading the following description and non-limiting embodiments, shown with reference to the appended drawings wherein:

FIG. 1 shows, in front view, a device usable according to the invention which is a mobile light exposure module 1 comprising a first double-sided light pulse emission module 3 held by a high-clearance device 5 mounted on a tractor 4.

FIG. 2 shows, in front view, an example of possible structure of a reflector body 7 of a device usable according to the invention comprising at least one light source 8, reflectors 9 and a temperature control block 10.

FIG. 3 shows, in profile view, the composition of an example of a reflector body 7 of a device usable according to the invention comprising the temperature control block 10 as well as a set of temperature and light power sensors 11.

FIG. 4 is a graph associated with example 1 making it possible to demonstrate the effects of the use of the device according to the invention on the percentage of buds and vine leaves that have frozen following a freeze.

FIG. 5 is a graph associated with example 2 making it possible to demonstrate the effects of the use of the device according to the invention on the yield of a vineyard following a heat wave.

FIG. 6 is a graph illustrating the average number of bunches per vine 29 days after a freeze on T0.

FIG. 7 is a graph illustrating the estimated percentage of fruiting buds in these two modalities.

### DESCRIPTION OF EMBODIMENTS

In this description, unless otherwise specified, it is understood that, when an interval is given, it includes the upper and lower bounds of said interval.

The invention relates to the use of a mobile to prevent impacts on a plant material linked to abiotic stresses.

The document WO9533374 discloses the use of a vehicle on rails moving laterally in order to emit a light discharge composed of a mixture of UV-A, B, C, visible and infrared light. The exposure time of the plants to this light discharge is less than ten seconds and preferentially three seconds. The use of this device is intended for the destruction of undesirable plants, but its use for prevention against impacts on a plant material linked to abiotic stresses is not envisaged.

Likewise, document EP3143869 describes a method for stimulating the resistance of plants to biotic stresses by applying UV-B and/or UV-C for a period of less than or equal to one second at doses of less than 10 KJ/m².

The person skilled in the art therefore does not suggest the use of UV radiations for the purposes of preventing impacts on plant material linked to abiotic stresses.

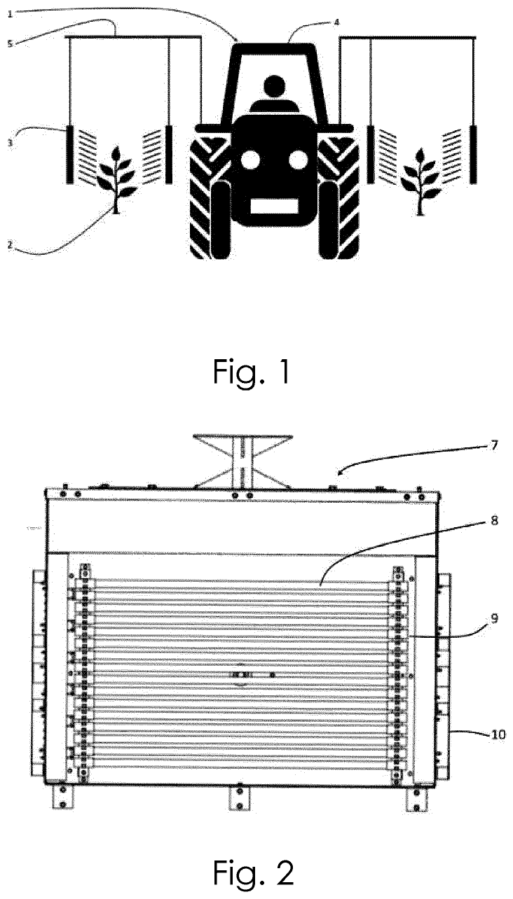

More particularly, the invention relates to the use of a mobile light exposure device 1 that delivers light pulses on a plant material 2, as shown in FIG. 1. Such a device advantageously comprises:
a first module for emitting 3 one or more light pulses, comprising at least one light treatment panel;
a second module for adjusting and/or switching on, remote from or on the device, for adjusting and/or switching on the optical power density of the treatment panel and optionally the temperature of said panel; and
a locomotive means 4 allowing for moving said device;

By light exposure, the Applicant refers to one or more light sources 8 coming from said device emitting at wavelengths between 200 nm and 780 nm (UV-C, UV-B, UV-A, visible light).

The first module of the mobile light exposure device 1 comprises at least one light treatment panel.

Preferably, the first module of the mobile light exposure device 1 comprises one or more discharge lamps making it possible to emit, continuously or in flashes, one or more light pulses on a plant material.

As non-limiting examples of usable lamps, mention may be made of low-, medium-, or high-pressure discharge lamps such as mercury vapor lamps (in particular with 254 nm rays), pulsed or xenon light lamps, Excimer lamps or light-emitting diode lamps.

According to the invention, the exposure time of the plants to this light discharge is less than four seconds and preferably less than or equal to two seconds.

The light pulses delivered on the plant material 2 are characterized in particular by their duration and by their identical or different wavelengths.

The term “light pulse” is understood to mean a light pulse perceived by the plant:
either by means of a device generating a continuous optical power density over time and delimited in space, which, by passing said device, creates a light pulse for the plant,
either by means of a device which generates light flashes (optical power density delimited in space and discontinuous in time) and which also passes along the rows.

In other words, the light pulses delivered on a plant material according to the invention can be generated either by flashes, for example pulsed light, or by passing a continuous light at a controlled speed, by moving a locomotive means 4.

Thus, the durations of the light pulses received by the plant material, whether by a continuously scattered light or a pulsed light, are necessarily less than four seconds, preferably less than or equal to two seconds.

Preferably, the duration of the light pulses delivered on the plant material is between two seconds and one tenth of a millisecond. More preferably, it is between one second and one hundredth of a second. The particularly preferred values used by the Applicant are one second, one tenth of a second, one hundredth of a second or even values between 300 μs and 500 μs.

The number and frequency of the light pulses are modulated as a function of the nature of the plant material 2 to be treated.

The wavelengths of the light pulses are generally between 200 nm and 780 nm (UV-C, UV-B, UV-A, visible light), preferentially between 200 nm and 280 nm (UV-C). Even more advantageously, they are between 220 nm and 260 nm.

According to a preferred embodiment of the invention, the light pulses delivered to a plant material 2 by the device according to the invention are derived from a continuous light preferentially scattering UV-C by a locomotive means launched at an average speed, that is between 1 km/h and 15 km/h, preferentially between 2 km/h and 10 km/h, more preferably between 3 km/h and 5 km/h.

According to an alternative embodiment of the invention, the light pulses can be UV-C flashes which are advantageously flashes of 0.5 to 2 seconds delivered by the device according to the invention by a locomotive means launched at a low speed, that is less than about 1 km/h, preferentially between 0.2 km/h and 1 km/h, more preferably between 0.5 km/h and 1 km/h. Furthermore, it is also possible to envisage superimposing different light pulses (differing by wavelength, duration or power) as the device passes.

This makes it possible in particular to use different light pulses simultaneously, separately or spread out over time.

Plant material is understood to mean an entire plant or part of a plant such as a leaf, fruit, stem, flower, or root.

Preferably, the plant material (2) is a plant, fruit, vegetable, vitroplant, algae, tuber or any other organ of a plant.

Preferably, said plant material 2 comes from farms comprising plantings. These plantings fall under agriculture, forestry, or horticulture, such as market crops, fruit-producing plants, grains, oleaginous crops, protein crops, medicinal or industrial crops.

As non-limiting examples of usable plant materials, mention may be made of the following plant families: Actinidiaceae, Amaranthaceae, Apiaceae, Arecaceae, Asteraceae, Brassicaceae, Cannabaceae, Cucurbitaceae, Fabaceae, Liliaceae, Lythraceae, Musaceae, Poaceae, Primulaceae, Rosaceae, Rubiaceae, Rutaceae, Solanaceae and Vitaceae.

Mention may also be made of grass, that is, any non-tree annual or perennial plant, a member of the monocotyledons, generally green in color. More particularly, grass commonly refers to graminoids, in particular forage grasses, which constitute the grasslands, prairies, and lawns, and families with similar morphology, Juncaceae (rushes) and Cyperaceae (sedges).

Preferably, the plant species used are:
Fragaria virginiana or Fragaria ananassa (Strawberry),
Fragaria vesca (Woodland strawberry),
Vaccinium macrocarpon (Cranberry),
Vaccinium vitis-idaea (Lingonberry),
Aronia melanocarpa (Blake chokeberry),
Vaccinium oxycoccos (Small cranberry),
Ribes nigrum (Blackcurrant),
Lycium barbarum (Goji or matrimony vine),
Ribes rubrum (Redcurrant),
Ribes uva-crispa (Gooseberry),
Vaccinium myrtillus (Blueberry),
Sambucus nigra (Elderberry),
Rubus idaeus (Raspberry),
Punica granatum (Pomegranate),
Prunus avium (Cherry),
Rubus fruticosus (Blackberry),
Rubusxloganobaccus (Loganberry),
Vitis vinifera (Grape vine),
Malus domestica (Apple),
Pyrus communis (Pear),
Prunus armeniaca (Apricot) and other forms of Prunus
Actinidia chinensis (Kiwi)
Solanum melongena (Eggplant),
Daucus carota (Carrot),
Lactuca sativa (Lettuce),
Cucumis sativus (Cucumber),
Capsicum annuum (Bell pepper),
Solanum tuberosum (Potato),
Cucurbita pepo (Zucchini),
Asparagus officinalis (Asparagus),
Rosa hybrida (Rose),
Gerbera sp. (Gerbera),
Cannabis sativa (Cannabis),
Cyclamen sp. (Cyclamen).

Preferably, the plant material 2 is selected from strawberry, tomato, rose, cucumber, berries, cannabis, grapevine, asparagus, potato, grass, apricot tree, and apple tree.

The second module for adjusting and/or switching on 6, not visible in FIG. 1, can be controlled remotely or directly on the device.

Preferably, the second module for adjusting and/or switching on 6 makes it possible both to adjust the optical power density of the treatment panel but also the temperature of said panel.

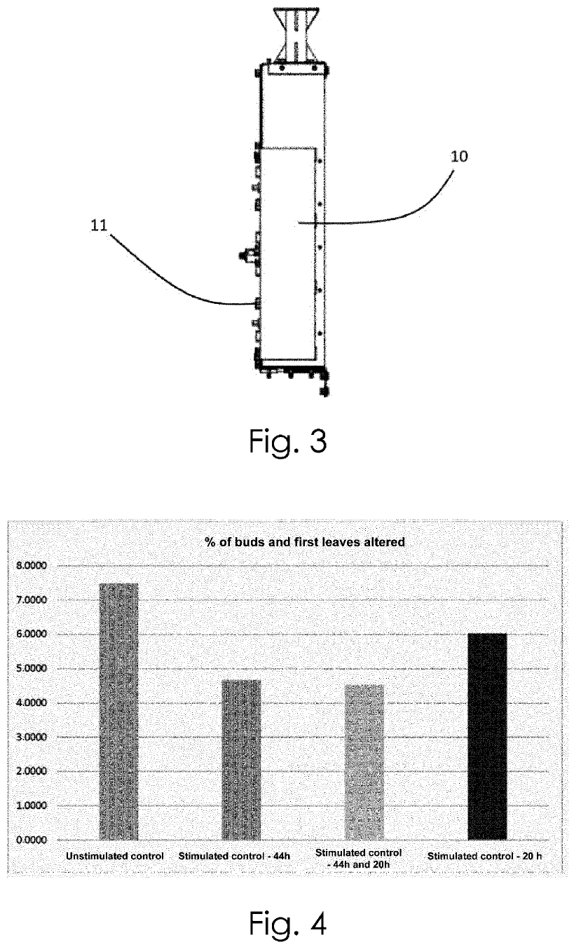

The temperature of the panel is actively regulated, by a fan, for example, or passively, by a thermal diffuser for example, by a temperature control block 10 which modifies the temperature thanks to the data it receives from a temperature sensor 11, as shown in FIG. 3.

More preferably, the second module for adjusting and/or switching on 6 makes it possible to control a mechanical adjusting module ensuring the correct positioning of the panels relative to the plant material 2, in particular when the latter is presented in the form of a low-height crop.

The optical power density of the panel allows the application of a dose of radiation on the plant material 2 of between 50 J/m² and 2,000 J/m² at the surface of a plant material, for all the forms of lamps with the exception of Xenon lamps (pulsed light), and between 1,000 and 20,000 J/m² for Xenon lamps, preferentially between 100 J/m² and 1,500 J/m² at the surface of a plant material for all the lamps other than Xenon lamps, and between 5,000 and 15,000 J/m² for Xenon lamps. The sources used may in particular be discharge lamps (in particular low-, medium- or high-pressure lamps, pulsed light, Excimer lamps) or LEDs. The cited light sources 8 may advantageously be mounted on a support called a reflector body 7 comprising reflectors 9 as well as the temperature regulating block 10, in order to control the light beam as shown in FIG. 2.

Even more preferentially, the optical power density of the panel allows the application of a dose of radiation of between 250 J/m² and 1,400 J/m² at the surface of a plant material, for all the forms of lamps with the exception of Xenon lamps and between 6,000 and 14,000 J/m² for Xenon lamps, advantageously between 200 J/m² and 1,200 J/m² at the surface of a plant material for all the lamps other than Xenon lamps, and between 8,000 and 12,000 J/m² for Xenon lamps.

Preferably:
the optical power density of the panel of the mobile light exposure device (1) allows an application of a radiation dose of between 50 J/m² and 2,000 J/m² to the surface of said plant material, for all the light sources other than pulsed light, and between 1,000 and 20,000 J/m² for pulsed light;
the light pulses delivered on the plant material (2) have identical or different wavelengths of between 200 nm and 780 nm (UV-C, UV-B, UV-A, visible light); and
the exposure times on said plant material are less than or equal to four seconds, preferably less than or equal to two seconds.

Preferably, the light pulses delivered by the mobile light exposure device (1) on said plant material (2) are obtained from continuously scattered light or by pulsed light and have identical or different wavelengths of between 200 nm and 280 nm (UV-C), preferentially between 220 nm and 260 nm, preferentially the light pulses are derived from a continuously scattered light.

Even more preferably, the radiation dose delivered by the mobile light exposure device (1) in the form of light pulses on said plant material (2) is between 100 J/m² and 1,500 J/m² at the surface of a plant material for all light sources other than pulsed light, and between 5,000 and 15,000 J/m² for pulsed light.

Of course, a person skilled in the art will be able to adapt the adjustments mentioned above as a function of the surface and of the plant material 2 to be treated.

The locomotive means 4 allows the device to move. The locomotive means 4 is advantageously a traction or propulsion means.

The locomotive means 4 or otherwise comprises drive wheels that can move over all types of surfaces or on rails. It may denote, depending on the nature of the surface, a traction apparatus composed of wheels and assisted or not by a motor. By way of non-limiting examples, we can use:
a wheelbarrow or cart;
a locomotive device composed of wheels moving on rails, for example in the form of a specialized treatment cart;
a tractor coupled to a high-clearance structure 5 for the largest areas to be treated, or
a storage space composed of straps to be transported on one's back, such as a backpack for example.

Preferably, the locomotive means 4 used is a traction or propulsion apparatus composed of wheels assisted by a thermal or electric motor.

The area of zones to be treated is variable and may generally range from 0.001 m² to 100 hectares. Preferably, the surface area of the zones to be treated corresponds to the size of a culture field, a tree nursery, a green space, a greenhouse, but also the size of a product obtained post-harvest.

According to the invention, the use of the mobile light exposure device enables the prevention of impacts on plant material from abiotic stresses.

“Impact on the plant material” means any damage that can be caused to a plant material resulting in an alteration in the yield and/or the quality of the plant material such as degraded metabolism, drying-out, burning, limited or stopped growth, irregular fruit development, or flower abortion.

Abiotic stresses are understood to mean environmental factors such as edaphic, climatic and/or chemical factors.

In a first embodiment of the invention, the use of the device enables the prevention of impacts on plant material related to edaphic factors.

Edaphic factors refer to the physical/chemical properties of the earth. These factors in particular comprise texture, particle size, structure, porosity, water content, degree of acidity, the content of minerals in the soil, to give a few non-limiting examples.

Preferably, edaphic factors correspond to saline stresses. There are two types of saline-related stresses:
water stress and
toxicity of sodium or chlorine due to their excessive accumulation in the plants' environment and in the plants themselves.

More preferably, edaphic factors correspond to the chemical contaminants present in the soil, such as heavy or non-heavy metals and any other chemical contaminant, for example derived from plant care products.

In a preferred embodiment of the invention, the use of the device enables the prevention of impacts on plant material related to climatic factors.

According to the invention, abiotic stresses are stresses related to climatic factors, preferentially high temperature variations relative to seasonal normals, freezes, hail, heat waves, or droughts.

Climatic factors may in particular include factors related to the amount, quality and distribution of water in an ecosystem. They also include the temperature, light and moisture of the air as non-limiting examples.

Preferably, the climatic factors correspond to high temperature variations, in particular relative to seasonal normals, freezes (temperature less than or equal to 0° C.), cold (temperature greater than 0° C. and less than 15° C.), hail, excessively frequent, long or intense periods of heat or drought, or unseasonal cold waves.

High temperature variations relative to seasonal normals are understood to mean any temperature variation greater than or equal to 4° C. relative to seasonal normals, i.e. an abnormal change in temperature perceptible to the plant which will lead to a modification of its metabolism and of its growth.

Seasonal normals are calculated over a period of 30 years and meet the rules defined by the World Meteorological Organization (WMO), in effect since the end of the 19th century. The normals currently used (1981-2010) are representative of the average climate over a period around the 1990s. For several years, global warming has been accelerating. Also, weather services around the world are currently updating the reference normals over the period 1991-2020. In early 2022, there will thus be a publication of new reference data on the climate, with a substantial change expected in particular for the various temperature-related indicators. The new climatic references will be “representative of a climate centered over the years around 2005”. There will therefore also be “a slight bias relative to the current period”. For example, the average temperature in June to Paris is between 13.8° C. min and 22.7° C. max, or an average of approximately 18° C. while precipitation is on average 38 mm.

These high temperature variations may also correspond to a temperature increase equal to ±30° C., ±27.5° C., ±25° C., ±22.5° C., ±20° C., ±17.5° C., ±15° C., ±12.5° C., ±10° C., ±5° C., or ±4° C., relative to an initial temperature of a plant, generated for example during heat waves. These temperature variations may also correspond to a temperature decline equal to −20° C., −17.5° C., −15° C., −12.5° C., −10° ° C., −5° C., or −4° C., relative to an initial temperature of a plant, generated for example during freezes.

The term “freezing” is understood in agriculture to mean any temperature of the air on the ground that falls to zero degrees Celsius or below.

Various types of freezing and frost are distinguished, such as:
white frost;
black frost;
advection frost;
radiation frost; and
evaporation frost.

These different types of frost can also refer to autumn frost, winter frost, and spring frost.

The terms freezing and frost can be used interchangeably.

The damage caused by freezing to plants is essentially due to the formation of ice crystals inside tissues, mainly between the cells.

To combat this damage, plants have protection mechanisms making it possible to counter the appearance of these crystals or to control the formation of these crystals in order to limit their damage.

These mechanisms allow the synthesis of defense proteins for notably combating abiotic stresses related to climatic factors such as freezing.

The proteins GLU-AFP, CHT-AFP, TLP-AFP in winter rye(Secale cereale), dcAFP in carrots (Daucus carota), TalRI1-2 in winter wheat (Triticum aestivum), BiCHT-1 in smooth bromegrass (Bromus inermis), PaAFP in Norway spruce (Picea abies), PpAFP in blue spruce (Picea pungens), CpCHT-AFP in wintersweet (Chimonanthus praecox) and HrCHT-1a/b in sea buckthorn(Hippophae rhamnoides) make it possible, for instance, to combat freezing by binding to ice crystals.

Also, the applicant was able to demonstrate an increase in the synthesis of such proteins during the use of the device according to the invention.

Some varieties of grapevine such as Sangiovese express genes involved in the synthesis of phenolic compounds, such as stilbene synthases. These genes are activated during freezes, and make it possible to lower the freezing temperature of the water.

Likewise, the Applicant was also able to demonstrate a strong activation of all the genes of “stilbene synthases”, about 35 different genes, by virtue of the use of the device according to the invention.

In another embodiment of the invention, the use of the device enables the prevention of impacts on plant material from stresses related to chemical factors.

Chemical factors in particular comprise atmospheric pollutants such as NOx, ozone, SO2

Another subject matter of the invention is a method for preventing and/or attenuating impacts of abiotic stresses on a plant material 2, by delivery of light pulses on said plant material, comprising the following steps of:
placing a mobile light exposure device 1 comprising a first module for emitting 3 one or more light pulses, comprising at least one light-treatment panel; a second module for adjusting and/or switching on 6, remote from or on the device, for adjusting and/or switching on the optical power density of the treatment panel and optionally the temperature of said panel; and a locomotive means 4 allowing the movement of said device, on a farm comprising plantings to be treated;
passing said device 1 delivering light pulses (UV-C, UV-B, UV-A, visible light) through the plantings, combined with direct exposure of said plant material 2 from plantings to light pulses of identical or different wavelengths and/or durations, wherein the wavelengths are identical or different and are between 200 nm and 780 nm (UV-C, UV-B, UV-A, visible light), preferentially between 200 nm and 280 nm (UV-C) and in that the exposure times are identical or different but of a duration less than or equal to four seconds, preferentially less than or equal to two seconds.

Preferentially, the method according to the invention is used in the prevention and/or attenuation of stress impacts related to climatic factors, preferentially high temperature variations relative to seasonal normals, freezing, hail, heat waves, or drought.

Even more preferentially, the method according to the invention can also be used for caring for or repairing impacts related to abiotic stresses.

Preferably, the climatic factors correspond to high temperature variations relative to seasonal normals, freezes, cold, hail, heat waves, or drought as described above.

Preferentially, the method according to the invention is suitable for a plant material 2 which is a plant, fruit, vegetable, vitroplant, tuber or any other organ of a plant.

The method according to the invention preferentially relates to a plant material selected from strawberry, tomato, rose, cucumber, berries, cannabis, grapevine, asparagus, potato, grass, apricot tree, and apple tree.

Surprisingly, the Applicant was able to demonstrate that the use of the device according to the invention and in particular the application of light pulses to a plant material 2 made it possible to obtain the following effects:
a reduced duration of applying the UV-C rays;
a stimulation of the production of defense proteins against abiotic stresses;
a better yield of plants having been exposed to abiotic stresses;
a better resistance of the plants exposed to a low temperature as in the event of a freeze, and
a better resistance of the plants exposed to a high temperature as in the event of a heat wave.

Particularly advantageously, the Applicant has also been able to demonstrate that the use of the device according to the invention also allows other complementary uses not proposed by other already-existing solutions such as those described above.

The Applicant has in particular been able to demonstrate that the use of the device according to the invention makes it possible to improve the yield and quality of the plants but also allows the elimination of pathogens on plant material.

The present invention will now be shown by means of the following examples.

### EXAMPLES

Example 1: Effect of the use of the device on the percentage of buds and vine leaves that have frozen following the freeze.

A test patch was set up in a Pinot Noir patch on a vineyard in Champagne.

This patch was divided into different modalities with different UV stimulation programs:
Unstimulated control;
Stimulated 44 hours before a freeze (T0-44 h);
Stimulated respectively 44 hours and 20 hours before a freeze (T0−44 H and T0−20 h);
Stimulated 20 hours before a freeze (T0−20 h)

The UV stimulations were carried out by a mobile device moving at a speed of between 2 and 5 km/h, equipped with mercury lamps for an optical power at 254 nm of between 200 and 1,500 W/m², operating continuously. The stimulations were all carried out between 6 and 11 a.m. The doses of UV-C (254 nm) received by the plant are between 100 and 1,500 J/m².

A freeze occurred at T0 between 5 and 7 a.m. with a minimum temperature of −1.6° C. and a hygrometry of 99.3%.

The percentage of buds and first leaves frozen was determined for each of the modalities.

FIG. 4 is a graph illustrating the percentage of buds and vine leaves that froze following the freeze that took place at T0.

### Conclusion

A significant protective and stimulating effect was observed on the patches compared to the unstimulated control, with a roughly 36% in the damage observed on the buds and leaves.

Moreover, the percentages of buds and leaves frozen are not significantly different for the modalities stimulated once at T−44 hours and stimulated at T−44 hours and T−20 hours.

However, a stimulation carried out the day before a freeze is less effective than a simple or double stimulation carried out several days before the freeze.

Example 2: Effect of the use of the device on the yield of a vineyard following a heat wave.

An application test for the use of the device according to the invention was carried out under production conditions on a patch of a vineyard. The UV stimulations were carried out by a mobile device moving at a speed of between 2 and 5 km/h, equipped with low-pressure mercury lamps for an optical power at 254 nm of between 200 and 1,200 W/m², operating continuously. The doses of UV-C (254 nm) received by the plant are between 100 and 1,500 J/m² at a frequency of about every 10 days.

For each test modality, blocks of 18 vines were stimulated or not.

The test site was subjected to a heat wave in July 2019 with local temperatures reaching values above 40° C. and accompanied by a marked absence of precipitation.

The crops were therefore subjected to thermal stress and potentially to water stress.

The average yield in kilograms of grape per grapevine was determined at the end of the season.

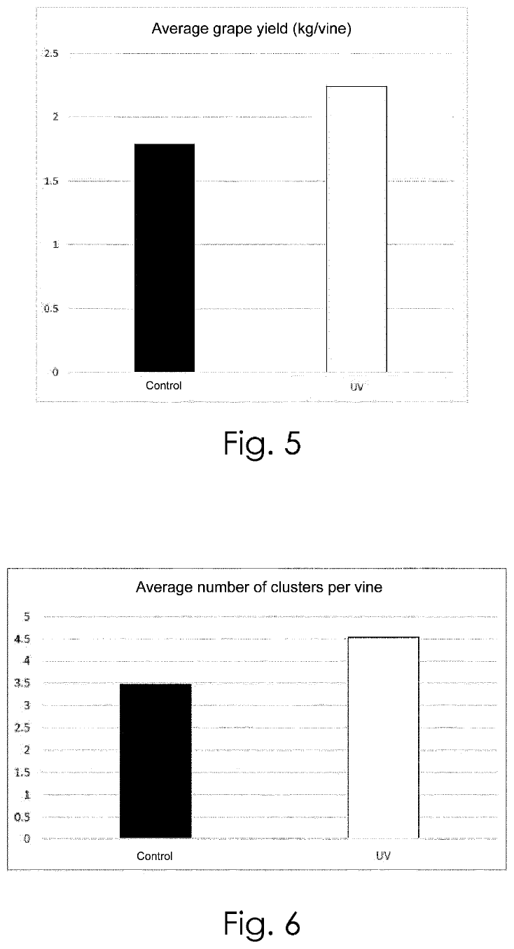

FIG. 5 is a graph that demonstrates the effect of using the device according to the invention on the average yield expressed in kilograms of grapes per grapevine at harvest, in a vineyard that has experienced a heat wave.

The yield is estimated for 35 grapevines randomized on four blocks for both groups. The difference observed is statistically significant according to a Student test with p=0.006.

### Conclusion

An increase of more than 25% of the average yield in kilograms of grapes was demonstrated for the modality of the test where the use of the device according to the invention was applied.

Example 3: Effect of the use of the device on the number of clusters per grapevine and of fruiting secondary buds of a vineyard following a spring frost.

A test patch was set up in a Pinot Noir patch on a vineyard in Aube.

This patch was divided into different modalities with different UV stimulation programs:
Unstimulated control;
Stimulated 44 hours (T−44 h) before a freeze and stimulated regularly, approximately every 10 to 15 days, preferentially every 12 days, after the freeze;
The UV stimulations were carried out by a mobile device moving at a speed of between 2 and 5 km/h, equipped with low-pressure mercury lamps for an optical power at 254 nm of between 200 and 1,200 W/m², operating continuously. The doses of UV-C (254 nm) received by the plant are between 100 and 1,000 J/m².

A freeze occurred between 5 and 7 a.m. (T0) with a minimum temperature of −1.6° C. and a hygrometry of 99.3%.

The number of clusters per grapevine was determined for each of the two modalities (control and UV) on May 31 by counting the number of clusters on 206 grapevines and 184 grapevines respectively.

FIG. 6 is a graph illustrating the average number of bunches per vine 29 days after the freeze on T0.

The percentage of fruiting secondary buds was estimated for these two modalities on June 4 on about thirty secondary buds in each of the modalities.

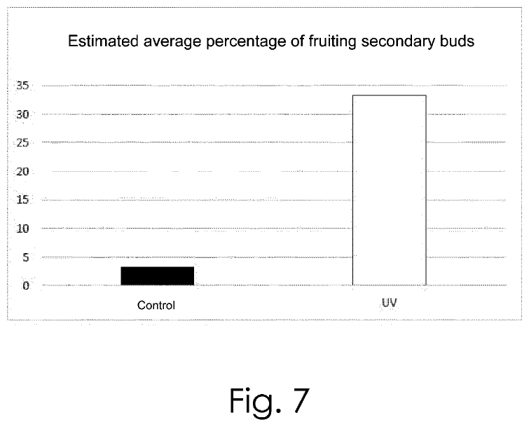

FIG. 7 is a graph illustrating the estimated percentage of fruiting secondary buds in these two modalities.

### Conclusion

A 32% increase in the average number of clusters per grapevine has been demonstrated for the modality of the test where the device according to the invention was used.

A tenfold increase in the average number of the percentage of fruiting secondary buds has been demonstrated for the modality of the test where the device according to the invention was used.

1. A mobile light exposure device (1) delivering light pulses on a plant material (2) comprising:
a first module configured for emitting (3) one or more light pulses, comprising at least one light treatment panel;
a second module configured for adjusting and/or switching on (6), remote from or on the device, an optical power density of the at least one light treatment panel and, optionally, a temperature of said at least one light treatment panel; and
a locomotive means (4) allowing for moving said device;
wherein said device emits said one or more light pulses in a manner that attenuated for the impacts on the plant material which are associated with abiotic stresses.

2. The mobile light exposure device according to claim 1,
wherein the abiotic stresses are stresses related to climatic factors.

3. The mobile light exposure device according to claim 1, wherein
the optical power density of the panel of the mobile light exposure device (1) allows an application of a radiation dose of between 50 J/m² and 2,000 J/m² to the surface of said plant material, for all the light sources other than pulsed light, and between 1,000 and 20,000 J/m² for pulsed light;
the light pulses delivered on the plant material (2) have identical or different wavelengths of between 200 nm and 780 nm (UV-C, UV-B, UV-A, visible light); and
the exposure times on said plant material are less than or equal to four seconds.

4. The mobile light exposure device according to claim 1, wherein the light pulses delivered by the mobile light exposure device (1) on said plant material (2) are obtained from continuously scattered light or by pulsed light and have identical or different wavelengths of between 200 nm and 280 nm (UV-C).

5. The mobile light exposure device according to claim 1, wherein the radiation dose delivered by the mobile light exposure device (1) in the form of light pulses on said plant material (2) is between 100 J/m² and 1,500 J/m² at the surface of a plant material for all light sources other than pulsed light, and between 5,000 and 15,000 J/m² for pulsed light.

6. The mobile light exposure device according to claim 1, wherein the plant material (2) is a plant, fruit, vegetable, vitroplant, algae, tuber or any other organ of a plant.

7. The mobile light exposure device according to claim 1, wherein said plant material (2) is chosen from strawberry, tomato, rose, cucumber, berries, cannabis, grapevine, asparagus, potato, grass, apricot tree, and apple tree.

8. A method for preventing and/or attenuating impacts of abiotic stresses on a plant material (2), by delivery of light pulses on said plant material (2), comprising the following steps of:
placing a mobile light exposure device (1) comprising a first module (3) for emitting one or more light pulses, comprising at least one light-treatment panel; a second module for adjusting and/or switching (6), remote from or on the device, for adjusting and/or switching on the optical power density of the treatment panel and optionally the temperature of said panel; and a locomotive means (4) allowing the movement of said device, on a farm comprising plantings to be treated;
passing said device (1) delivering light pulses (UV-C, UV-B, UV-A, visible light) through the plantings, combined with direct exposure of said plant material (2) from plantings to light pulses of identical or different wavelengths and/or durations,
wherein the wavelengths are identical or different and are between 200 nm and 780 nm (UV-C, UV-B, UV-A, visible light), and in that the exposure times are identical or different but of a duration less than or equal to four seconds.

9. The method according to claim 8, wherein it is used in the attenuation of stress impacts related to climatic factors.

10. The method according to claim 8, wherein the plant material (2) is chosen from strawberry, tomato, rose, cucumber, berries, cannabis, grapevine, asparagus, potato, grass, apricot tree, and apple tree.

11. The mobile light exposure device according to claim 3, wherein the exposure times on said plant material are less than or equal to two seconds.

12. The mobile light exposure device according to claim 4, wherein the light pulses are derived from the continuously scattered light.

13. The mobile light exposure device according to claim 12, wherein the continuously scattered light has wavelengths of between 220 nm and 260 nm.

14. The mobile light exposure device according to claim 8, wherein the exposure times on said plant material are less than or equal to two seconds.

15. The mobile light exposure device according to claim 8, wherein the light pulses are derived from the continuously scattered light.

16. The mobile light exposure device according to claim 15, wherein the continuously scattered light has wavelengths of between 220 nm and 260 nm.
